(19) United States
(12) Patent Application Publication
(10) Pub. No.: US 2026/0048453 A1
(43) Pub. Date: Feb. 19, 2026

(54) METHOD FOR REPAIRING BABBITT METAL BEARING SHOE BY LASER CLADDING

(71) Applicants: CHINA YANGTZE POWER CO., LTD, Wuhan (CN); NANJING HUIRUI OPTOELECTRONIC TECHNOLOGY CO., LTD, Nanjing (CN)

(72) Inventors: Hui LIU, Wuhan (CN); Tao WU, Wuhan (CN); Jin XU, Wuhan (CN); Jian DENG, Wuhan (CN); Ming MA, Wuhan (CN); Liuming XU, Wuhan (CN); Tao QIU, Wuhan (CN); Xiaoping ZHANG, Wuhan (CN)

(73) Assignees: CHINA YANGTZE POWER CO., LTD, Wuhan, HB (CN); NANJING HUIRUI OPTOELECTRONIC TECHNOLOGY CO., LTD, Nanjing, JS (CN)

(21) Appl. No.: 19/104,228

(22) PCT Filed: Apr. 28, 2023
(86) PCT No.: PCT/CN2023/091657

§ 371 Date: Feb. 17, 2025

(30) Foreign Application Priority Data
Aug. 27, 2022 (CN) 202211035975.9

(51) Int. Cl. B23K 26/342

(52) U.S. Cl. CPC B23K 26/342

(57) ABSTRACT

Disclosed is a method for repairing a Babbitt metal bearing shoe by laser cladding, metal plates are placed around a cladding range, thereby assisting in cooling a cladding area and accelerating heat conduction of a base material in the cladding area, and since the metal plates protrude out of a surface of the cladding area to form a step-like shape, thereby avoiding a phenomenon of an undercut of an edge side cladding channel; and by planning an area to be repaired, the cladding area is limited in a range as small as possible, and in addition, the metal plates are arranged around the cladding area for cooling, thereby avoiding a phenomenon of decladding of an original Babbitt metal layer caused by overheating deformation.

### TECHNICAL FIELD

The present invention relates to the technical field of laser cladding, and particularly refers to a method for repairing a Babbitt metal bearing shoe by laser cladding.

### BACKGROUND OF THE INVENTION

Babbitt metal is widely used as a material for preparing a bearing bush, a bearing, a lining and other parts of a main shaft in ships, vehicles and large machines due to the characteristics of small expansion coefficient, good thermal conductivity, and excellent corrosion resistance and wear reduction performance. Hydraulic turbine thrust shoe is a plane thrust bearing, and at present, a main production method of the thrust shoe is to cast the Babbitt metal on a billet. A bonding strength between the Babbitt metal of the thrust shoe formed by a gravity casting process and the billet of the bearing shoe is low, and a machining allowance of a Babbitt metal layer formed is large, so that this traditional technology is gradually being replaced by new technologies such as laser cladding. Compared with the traditional processing method, a laser additive manufacturing method has a simple process flow, and low material and energy consumption, and the Babbitt metal formed by the method has a fine and uniform structure, a low porosity and a higher bonding strength with a base material.

CN112981395A provides a method for repairing a thrust shoe based on laser cladding, and CN107803501B provides a laser additive manufacturing method for a tin-based Babbitt method component. The prior arts mainly aim at cladding the Babbitt metal on a steel or tin bronze matrix to achieve the purpose of repairing or new product manufacturing. Because the thrust shoe bears a weight of a rotating part of a whole unit and an axial water thrust, defects such as scratches, wears and shrinkage cavities may be exposed after a period of use, which will affect the normal operation of the unit, so that the thrust shoe must be replaced in time. In existing repairing methods, recasting and laser cladding both need to completely remove an original residual Babbitt metal layer.

Different from cladding the Babbitt metal on a steel base material, the main problems in local repairing on the Babbitt metal comprise an undercut and the decladding of the original Babbitt layer. Because a melting point of the Babbitt metal is only over 200° C., a groove or a recess is easy to be generated on an edge of a repairing area during cladding, which is called the undercut. When the repaired original thrust shoe is made by a casting process, a bonding strength between an original Babbitt metal layer and the billet is low. Under an action of laser cladding, the original Babbitt metal layer may be heated to deform under a stress, and when the stress is greater than the bonding strength between the two layers, the original Babbitt metal layer will be separated from the billet to cause decladding.

### SUMMARY OF THE INVENTION

The present invention is intended to overcome the above defects, and to provide a method for repairing a Babbitt metal bearing shoe by laser cladding, which does not need to completely remove an original Babbitt metal layer, and realizes local repair on the original Babbitt metal layer, thereby reducing material consumption and maintenance costs, and effectively reducing phenomena such as an undercut on an edge of a repairing area and decladding.

In order to solve the above technical problems, the technical solution adopted by the present invention is: a method for repairing a Babbitt metal bearing shoe by laser cladding, which comprises the following steps of:
S1: comprehensively inspecting a Babbitt metal thrust shoe of a unit to be repaired, and confirming that a billet part of the thrust shoe is intact;
S2: removing an area with porosity, needle holes and air holes on a surface of Babbitt metal by machining, and retaining an original Babbitt metal layer in other areas;
S3: cleaning a surface of the Babbitt metal thrust shoe to remove an oil pollutant on the surface;
S4: dividing the surface of the Babbitt metal thrust shoe and marking divided areas with numbers, and marking an area to be repaired on which a new Babbitt metal layer needs to be formed by laser cladding;
S5: planning a laser cladding path in the area to be repaired, and determining a quadrilateral cladding range, wherein a laser scanning direction is along long sides of the quadrilateral, and an overlapping direction is along short sides of the quadrilateral, so as to ensure that the cladding range covers all defects in the area;
S6: respectively placing four metal plates in edge positions of the quadrilateral cladding area on the thrust shoe, wherein the metal plates protrude out of the surface of the cladding area to form a step-like shape;
S7: on the basis of determining the cladding range in the S5, setting a starting point and an ending point of each channel of laser cladding to extend outwards to two sides at a certain distance, and determining an overlap ratio and a number of cladding channels according to a cladding process and a width of the cladding quadrilateral, so as to complete cladding programming;
S8: selecting Babbitt metal powder of a corresponding brand according to a component detection result of the Babbitt metal thrust shoe, and forming the Babbitt metal with a certain thickness on the surface of the area to be repaired by laser cladding;
S9: in the S8, when a first channel and a last channel of laser cladding are formed, keeping a laser cladding head at a certain deflection angle in a plane perpendicular to the laser scanning direction;
S10: after completing repair of one area to be repaired, repairing a next area to be repaired by a same method until all areas are repaired; and
S11: keeping a certain margin on the surface of the Babbitt metal thrust shoe after completing laser cladding, and according to specific requirements of a drawing, restoring the thrust shoe to meet a drawing size and related requirements by milling and grinding.

Preferably, in the S2, when the area with porosity, needle holes and air holes on the surface of the Babbitt metal is removed by machining, a removal amount only refers to eliminating the above defects visible to naked eyes.

Preferably, in the S4, the marked area to be repaired on which the new Babbitt metal layer needs to be formed by laser cladding comprises a worn area and an area removed by machining.

Preferably, in the S5, the quadrilateral comprises a rectangle or a parallelogram or a trapezoid.

Preferably, in the S6, the metal plate is a copper alloy plate or iron plate or carbon steel plate structure, and a thickness of the metal plate is 5 mm to 8 mm.

Preferably, an interior of the metal plate is also provided with a cooling water channel for introducing cooling water to cool the metal plate.

Preferably, in the S7, on the basis of determining the cladding range in the S5, the starting point and the ending point of each channel of laser cladding are set to extend outwards to two sides at a distance of 5 mm to 20 mm.

Preferably, in the S8, specific process parameters of laser cladding are: a spot diameter of 2 mm to 5 m, laser cladding power of 400 W to 1000 W, a cladding speed of 8 mm/s to 15 mm/s, a powder feeding amount of 8 g/min to 25 g/min, and a cladding channel overlap ratio of 40% to 60%.

Preferably, in the S9, when the first channel and the last channel of laser cladding are formed, an included angle between the laser cladding head in the plane perpendicular to the laser scanning direction and a normal of the cladding area is 15° to 45°.

Preferably, in the S9, when the first channel and the last channel of laser cladding are formed, the laser cladding head deflects towards an interior of the quadrilateral cladding range in the plane perpendicular to the laser scanning direction, and at this time, the included angle between the laser cladding head and the normal of the cladding area is 15° to 45°.

The present invention has the beneficial effects as follows:
1. The present invention does not need to completely remove the original Babbitt metal layer, and realizes local repair on the original Babbitt metal layer, thereby reducing material consumption and maintenance costs, and effectively reducing phenomena such as an undercut on an edge of a repairing area and decladding, which will reduce a lot of waste of materials and shorten repair time, so as to bring higher maintenance efficiency and greater benefits to enterprises.
2. According to cladding program setting, starting and ending parts of each channel of cladding are carried out on the metal plate, which avoids the problem of excessive energy input to the Babbitt metal base material caused by acceleration and deceleration stages during starting and ending of a laser scanning movement, and avoids a collapse phenomenon in starting and ending positions of a cladding channel.
3. The metal plates are placed around the cladding range, thereby assisting in cooling the cladding area and accelerating heat conduction of the base material in the cladding area, and since the metal plates protrude out of the surface of the cladding area to form the step-like shape, thereby avoiding a phenomenon of an undercut of an edge side cladding channel.
4. By planning the area to be repaired, the cladding area is limited in a range as small as possible, and meanwhile, the metal plates are arranged around the cladding area for cooling, thereby avoiding a phenomenon of decladding of the original Babbitt metal layer caused by overheating deformation.

### BRIEF DESCRIPTION OF DRAWINGS

FIG. 1 is a schematic diagram of marking of one area to be repaired corresponding to step S4 in the present invention;

FIG. 2 is a schematic diagram of marking of another area to be repaired corresponding to the step S4 in the present invention;

FIG. 3 is a schematic structural diagram of metal plates arranged on a surface of a cladding area in step S3 in the present invention; and

FIG. 4 is a schematic diagram of a laser scanning direction and a laser cladding head arranged above the cladding area corresponding to step S9 in the present invention.

### DETAILED DESCRIPTION OF THE INVENTION

The present invention is further described in detail hereinafter with reference to the drawings and the specific embodiments.

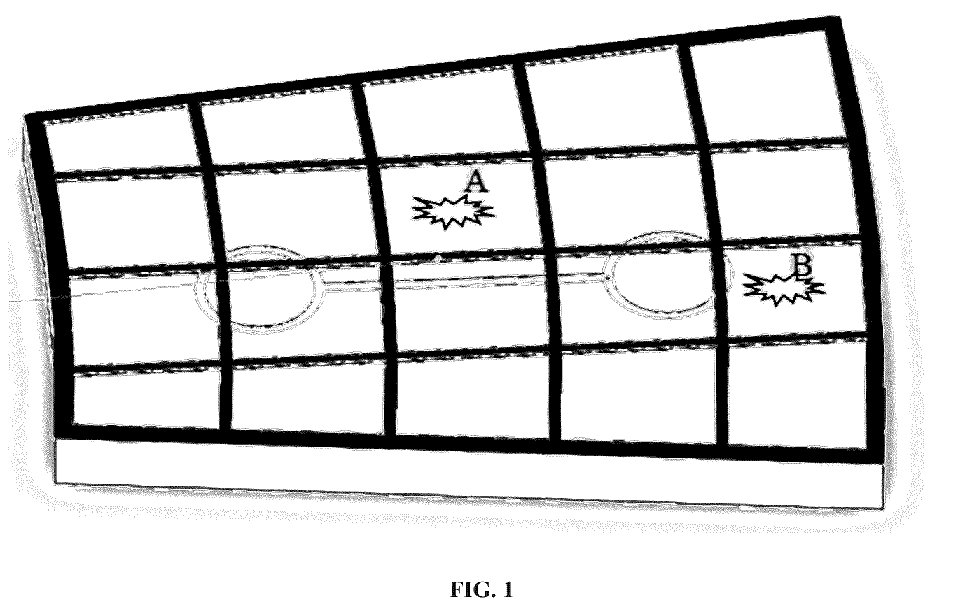

As shown in FIG. 1, a method for repairing a Babbitt metal bearing shoe by laser cladding comprises the following steps.

In S1, a Babbitt metal thrust shoe of a unit to be repaired is comprehensively inspected, and it is confirmed that a billet part of the thrust shoe is intact.

In S2, an area with porosity, needle holes and air holes on a surface of Babbitt metal is removed by machining, and an original Babbitt metal layer in other areas is retained. In this step, as many original Babbitt alloy layers as possible may be retained.

In S3, a surface of the Babbitt metal thrust shoe is cleaned to remove an oil pollutant on the surface.

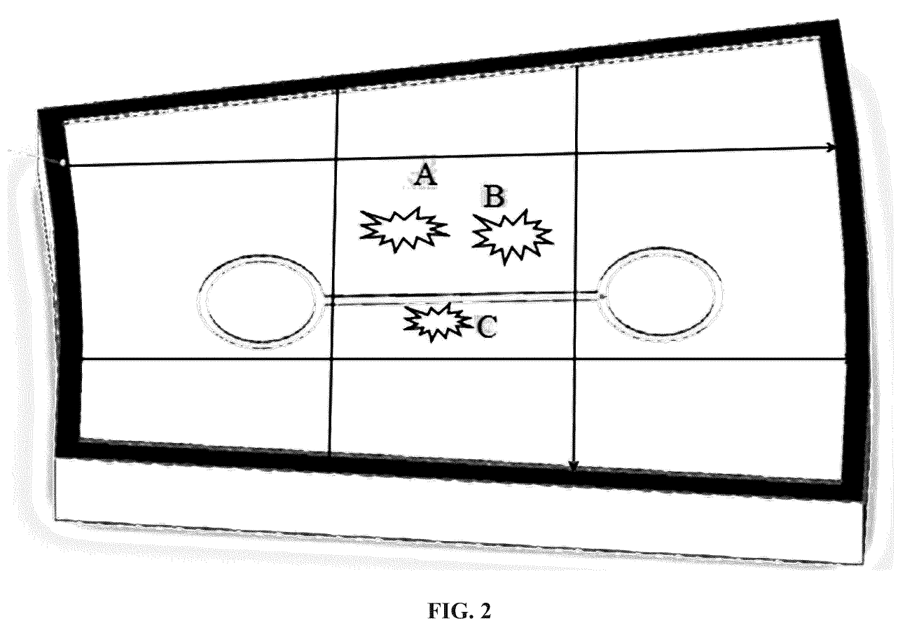

In S4, the surface of the Babbitt metal thrust shoe is divided and marked with numbers, and an area to be repaired on which a new Babbitt metal layer needs to be formed by laser cladding is marked. In addition, according to actual damage situations (defect size and distribution) on the surface of the thrust surface, a division strategy is adjusted, so that a defect to be repaired is located in a center of the planned area to be repaired, and a single area to be repaired should be as small as possible. For example, in FIG. 1, defects A and B are distributed in a loose manner, and then the two defects are marked in two areas to be repaired respectively. In FIG. 2, defects A, B and C are distributed in a concentrated manner, and then the defects are divided into a large area to be repaired together.

In S5, a laser cladding path is planned in the area to be repaired, and a quadrilateral cladding range is determined, wherein a laser scanning direction is along long sides of the quadrilateral, and an overlapping direction is along short sides of the quadrilateral, so as to ensure that the cladding range covers all defects in the area.

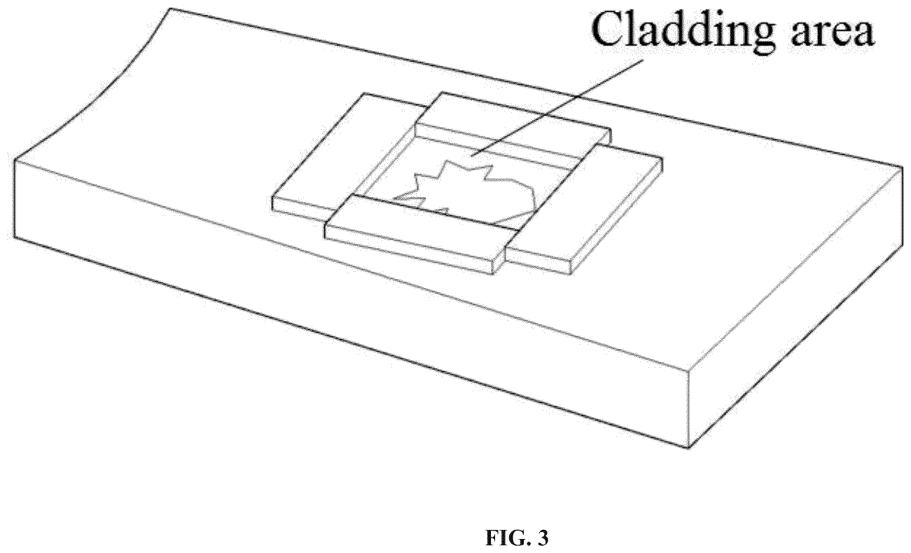

In S6, as shown in FIG. 3, four metal plates are respectively placed in edge positions of the quadrilateral cladding area on the thrust shoe, wherein the metal plates protrude out of the surface of the cladding area to form a step-like shape. The metal plates enclose the quadrilateral cladding area on the thrust shoe herein, and the metal plates protrude out of the surface of the cladding area to form the step-like shape, so that an edge of the cladding area is not easy to generate an undercut during laser cladding. In addition, the metal plate generally has good thermal conductivity, so that heat generated in the cladding area can be quickly absorbed and dissipated, which can effectively reduce the phenomenon of decladding.

In S7, on the basis of determining the cladding range in the S5, a starting point and an ending point of each channel of laser cladding are set to extend outwards to two sides at a certain distance, and an overlap ratio and a number of cladding channels are determined according to a cladding process and a width of the cladding quadrilateral, so as to complete cladding programming.

In S8, Babbitt metal powder of a corresponding brand is selected according to a component detection result of the Babbitt metal thrust shoe, and the Babbitt metal with a certain thickness is formed on the surface of the area to be repaired by laser cladding.

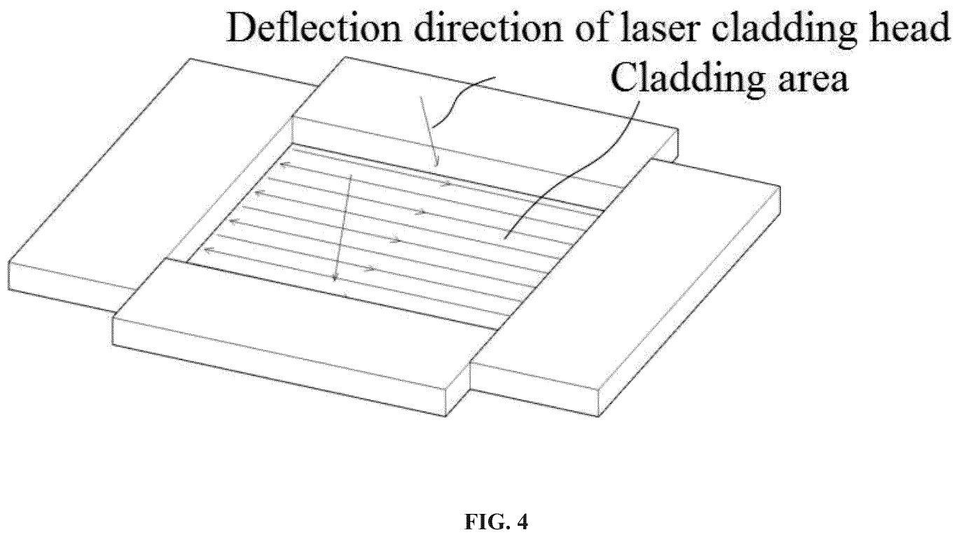

In S9, in the S8, when a first channel and a last channel of laser cladding are formed, a laser cladding head is kept at a certain deflection angle (as shown in FIG. 4) in a plane perpendicular to the laser scanning direction.

In S10, after completing repair of one area to be repaired, a next area to be repaired is repaired by a same method until all areas are repaired.

In S11, a certain margin is kept on a surface of the Babbitt metal thrust shoe after completing laser cladding, and according to specific requirements of a drawing, the thrust shoe is restored to meet a drawing size and related requirements by milling and grinding.

Preferably, in the S2, when the area with porosity, needle holes and air holes on the surface of the Babbitt metal is removed by machining, a removal amount only refers to eliminating the above defects visible to naked eyes.

Preferably, in the S4, the marked area to be repaired on which the new Babbitt metal layer needs to be formed by laser cladding comprises a worn area and an area removed by machining.

Preferably, in the S5, the quadrilateral comprises a rectangle or a parallelogram or a trapezoid.

Preferably, in the S6, the metal plate is a copper alloy plate or iron plate or carbon steel plate structure, and a thickness of the metal plate is 5 mm to 8 mm. According to the above metal plates, especially the copper alloy plate has a low laser absorption rate, and is not easy to weld with the cladding area, and meanwhile, the copper alloy plate has a better heat dissipation performance, and can conduct heat and dissipate heat quickly; and in addition, the carbon steel plate may also be used as backup because of a low cost.

Preferably, an interior of the metal plate is also provided with a cooling water channel for introducing cooling water to cool the metal plate. By arranging the cooling water channel, the heat conducted into the metal plate may be absorbed faster, so that a cooling effect of the metal plate is improved, and the heat generated in the cladding area is quickly dissipated, thereby further reducing the phenomenon of cladding.

Preferably, in the S7, on the basis of determining the cladding range in the S5, the starting point and the ending point of each channel of laser cladding are set to extend outwards to two sides at a distance of 5 mm to 20 mm. According to this step, starting and ending parts of each channel of cladding are carried out on the metal plate, which avoids the problem of excessive energy input to the Babbitt metal base material caused by acceleration and deceleration stages during starting and ending of a laser scanning movement, and avoids a collapse phenomenon in starting and ending positions of a cladding channel.

Preferably, in the S8, specific process parameters of laser cladding are: a spot diameter of 2 mm to 5 m, laser cladding power of 400 W to 1000 W, a cladding speed of 8 mm/s to 15 mm/s, a powder feeding amount of 8 g/min to 25 g/min, and a cladding channel overlap ratio of 40% to 60%.

Preferably, in the S9, when the first channel and the last channel of laser cladding are formed, an included angle between the laser cladding head in the plane perpendicular to the laser scanning direction and a normal of the cladding area is 15° to 45° (as shown in FIG. 4). It can be seen from the figure that an overall translational scanning direction of the laser cladding head refers to reciprocating from left to right, for example, the first channel is from left to right, and the second channel is from right to left, and during laser cladding of the first channel, the laser cladding head keeps a certain deflection angle, so that a laser irradiation direction refers to an obliquely downward direction, and is aimed at an area of the first channel; and the reason for this design is that, during laser cladding, each channel overlaps with each other, the first channel and the last channel of laser cladding are the most prone to the problem of recess (that is the undercut), and by keeping the laser cladding head at the certain deflection angle, an oblique force may be exerted on an edge area (such as the area of the first channel) in which the undercut may be generated to form an effect similar to pit filling, so that the possibility of generating the undercut will be greatly reduced.

Preferably, in the S9, when the first channel and the last channel of laser cladding are formed, the laser cladding head deflects towards an interior of the quadrilateral cladding range in the plane perpendicular to the laser scanning direction, and at this time, the included angle between the laser cladding head and the normal of the cladding area is 15° to 45° (as shown in FIG. 4). When the first channel and the last channel of laser cladding are formed, the laser cladding head deflects towards the interior of the quadrilateral cladding range, so that the first channel and the last channel of laser cladding may be as close as possible to the edge of the metal plate, and the edge position is not easy to generate the undercut.

The above embodiments are only preferred technical solutions of the present invention, and should not be regarded as limiting the present invention. The embodiments in the present application and the features in the embodiments can be arbitrarily combined with each other without conflict. The scope of protection of the present invention shall be the technical solutions recorded in the claims, including the equivalent alternatives of the technical features in the technical solutions recorded in the claims. Equivalent substitutions and improvements in the scope are also included in the scope of protection of the present invention.

What is claimed is:

1. A method for repairing a Babbitt metal bearing shoe by laser cladding, comprising the following steps of:
S1: comprehensively inspecting a Babbitt metal thrust shoe of a unit to be repaired, and confirming that a billet part of the thrust shoe is intact;
S2: removing an area with porosity, needle holes and air holes on a surface of Babbitt metal by machining, and retaining an original Babbitt metal layer in other areas;
S3: cleaning a surface of the Babbitt metal thrust shoe to remove an oil pollutant on the surface;
S4: dividing the surface of the Babbitt metal thrust shoe and marking divided areas with numbers, and marking an area to be repaired on which a new Babbitt metal layer needs to be formed by laser cladding;
S5: planning a laser cladding path in the area to be repaired, and determining a quadrilateral cladding range, wherein a laser scanning direction is along long sides of the quadrilateral, and an overlapping direction is along short sides of the quadrilateral, so as to ensure that the cladding range covers all defects in the area;
S6: respectively placing four metal plates in edge positions of the quadrilateral cladding area on the thrust shoe, wherein the metal plates protrude out of the surface of the cladding area to form a step-like shape;
S7: on the basis of determining the cladding range in the S5, setting a starting point and an ending point of each channel of laser cladding to extend outwards to two sides at a certain distance, and determining an overlap ratio and a number of cladding channels according to a cladding process and a width of the cladding quadrilateral, so as to complete cladding programming;
S8: selecting Babbitt metal powder of a corresponding brand according to a component detection result of the Babbitt metal thrust shoe, and forming the Babbitt metal with a certain thickness on the surface of the area to be repaired by laser cladding;
S9: in the S8, when a first channel and a last channel of laser cladding are formed, keeping a laser cladding head at a certain deflection angle in a plane perpendicular to the laser scanning direction;
S10: after completing repair of one area to be repaired, repairing a next area to be repaired by a same method until all areas are repaired; and
S11: keeping a certain margin on the surface of the Babbitt metal thrust shoe after completing laser cladding, and according to specific requirements of a drawing, restoring the thrust shoe to meet a drawing size and related requirements by milling and grinding.

2. The method for repairing the Babbitt metal bearing shoe by laser cladding according to claim 1, wherein, in the S2, when the area with porosity, needle holes and air holes on the surface of the Babbitt metal is removed by machining, a removal amount only refers to eliminating the above defects visible to naked eyes.

3. The method for repairing the Babbitt metal bearing shoe by laser cladding according to claim 1, wherein, in the S4, the marked area to be repaired on which the new Babbitt metal layer needs to be formed by laser cladding comprises a worn area and an area removed by machining.

4. The method for repairing the Babbitt metal bearing shoe by laser cladding according to claim 1, wherein, in the S5, the quadrilateral comprises a rectangle or a parallelogram or a trapezoid.

5. The method for repairing the Babbitt metal bearing shoe by laser cladding according to claim 1, wherein, in the S6, the metal plate is a copper alloy plate or iron plate or carbon steel plate structure, and a thickness of the metal plate is 5 mm to 8 mm.

6. The method for repairing the Babbitt metal bearing shoe by laser cladding according to claim 1, wherein an interior of the metal plate is also provided with a cooling water channel for introducing cooling water to cool the metal plate.

7. The method for repairing the Babbitt metal bearing shoe by laser cladding according to claim 1, wherein, in the S7, on the basis of determining the cladding range in the S5, the starting point and the ending point of each channel of laser cladding are set to extend outwards to two sides at a distance of 5 mm to 20 mm.

8. The method for repairing the Babbitt metal bearing shoe by laser cladding according to claim 1, wherein, in the S8, specific process parameters of laser cladding are: a spot diameter of 2 mm to 5 m, laser cladding power of 400 W to 1000 W, a cladding speed of 8 mm/s to 15 mm/s, a powder feeding amount of 8 g/min to 25 g/min, and a cladding channel overlap ratio of 40% to 60%.

9. The method for repairing the Babbitt metal bearing shoe by laser cladding according to claim 1, wherein, in the S9, when the first channel and the last channel of laser cladding are formed, an included angle between the laser cladding head in the plane perpendicular to the laser scanning direction and a normal of the cladding area is 15° to 45°.

10. The method for repairing the Babbitt metal bearing shoe by laser cladding according to claim 9, wherein, in the S9, when the first channel and the last channel of laser cladding are formed, the laser cladding head deflects towards an interior of the quadrilateral cladding range in the plane perpendicular to the laser scanning direction, and at this time, the included angle between the laser cladding head and the normal of the cladding area is 15° to 45°.
